(19) United States
(12) Patent Application Publication
(10) Pub. No.: US 2005/0105523 A1
(43) Pub. Date: May 19, 2005

(54) Web AV recording device and method of the same

(76) Inventors: Shih-Hsiung Weng, Taipei (TW); Sun-Loi Lai, Penang (MY)

Correspondence Address: RABIN & BERDO, P.C., Suite 500, 1101 14 Street, N.W., Washington, DC, 20005, US

(21) Appl. No.: 10/715,411

(22) Filed: Nov. 19, 2003

(51) Int. Cl. H04L 12/56

(52) U.S. Cl. 370/389

(57) ABSTRACT

The specification discloses a web AV recording device and the corresponding method. The device includes connectors, a transceiver, a storage device, and a processor. The connectors connect to external web devices. The transceiver connects to the connectors for transceiving AV signals. The storage device stores a comparison table, which records the correspondence between web device address and web addresses. The processor connects to the transceiver and the storage device. After the processor receives the AV signals transmitted from the transceiver, the AV signals are processed according to their internal and external signal forms. Therefore, the invention can process its internal and external AV signals and transmit AV signals between two web devices.

### BACKGROUND OF THE INVENTION

1. Field of Invention

The invention relates to a web AV recording device and the method thereof.

2. Related Art

There are increasing demands in the multimedia device market. The demands in audio/video (AV) recording devices are also rising. However, most AV recording devices can merely process audio and video recording. Therefore, they are not very useful when one wants to connect them to external devices for distant AV recording. Moreover, existing AV recording devices can only process certain AV files. They cannot satisfy the needs for multimedia devices with multiple functions.

### SUMMARY OF THE INVENTION

A primary objective of the invention is to provide a web AV recording device and the corresponding method. In addition to processing its own AV signals, it can further process external AV signals. It can even facilitate transmissions of AV signals from one web device to another for processing.

The disclosed web AV recording device has connectors, a transceiver, a storage device, and a processor. The connectors connect to external web devices. The transceiver connects to the connectors for transceiving AV signals. The storage device stores a comparison table, which records the correspondence between web device address and web addresses. The processor connects to the transceiver and the storage device. After the processor receives the AV signals transmitted from the transceiver, the AV signals are scheduled for processing if they are recognized as internal signals. If the received AV signals are external, they are scheduled to be transmitted to another web device after determining the web address and comparing with the comparison table. Therefore, the invention can process its internal and external AV signals and transmit AV signals between two web devices.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of the disclosed web AV recording device;

FIGS. 2A and 2B are flowcharts of the disclosed web AV recording method; and

FIG. 3 shows the details of the disclosed method.

### DETAILED DESCRIPTION OF THE INVENTION

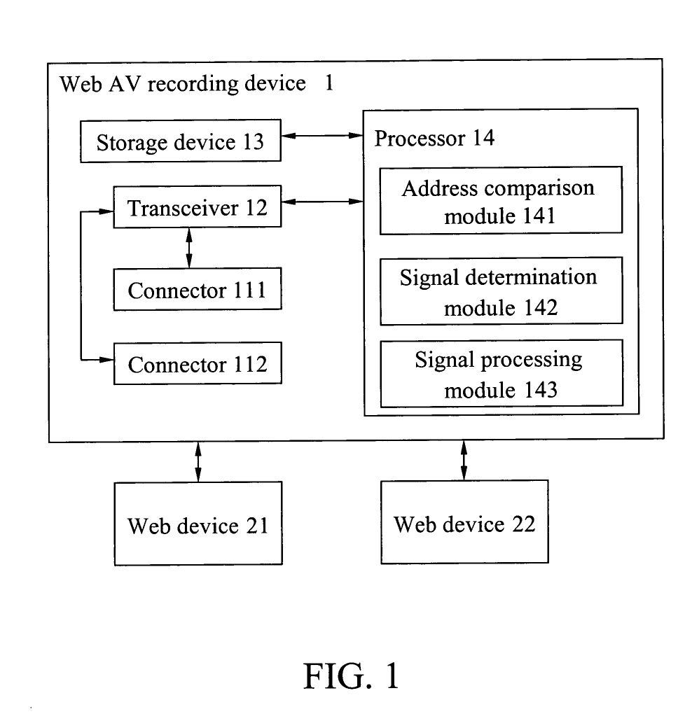

As shown in FIG. 1, the web AV recording device 1 disclosed herein contains connectors 111, 112, a transceiver 12, a storage device 13, and a processor 14. The connectors 111, 112 connect to external web devices 21, 22. The transceiver 12 connects to the connectors 111, 112 for transceiving AV signals. The storage device 13 stores a comparison table that records correspondence relations between the addresses of the web devices 21, 22 and the web addresses. The processor 14 connects to the transceiver 12 and the storage device 13. It further includes an address comparison module 141, a signal determination module 142, and a signal processing module 143.

Before functioning, a comparison table is first established. The transceiver 12 receives the addresses of the web devices 21, 22 and their web addresses. The transceiver 12 sends the information to the address comparison module 141 to establish the comparison table. Once this is done, the address comparison module 141 sends the comparison table to the storage device 11 for storage.

After the transceiver 12 receives AV signals from the connectors 111, 112, the signal determination module 142 checks the AV signals and determines whether they are internal or external signals. The AV signals are then sent to the signal processing module 143. The signal processing module 143 schedules the internal AV signals for subsequent processing and the external AV signals for verifying their destination web address as the web device 21 (22). The storage device 11 uses the comparison table to perform comparisons. If the destination web address is not a web device, then the AV signals are sent to the corresponding device.

In addition to processing its own AV signals, the invention can further process external AV signals or transmit AV signals from one web device 21 (22) to another web device 22 (21). Thus, the web transmission function provided by the invention can facilitate signal transmissions.

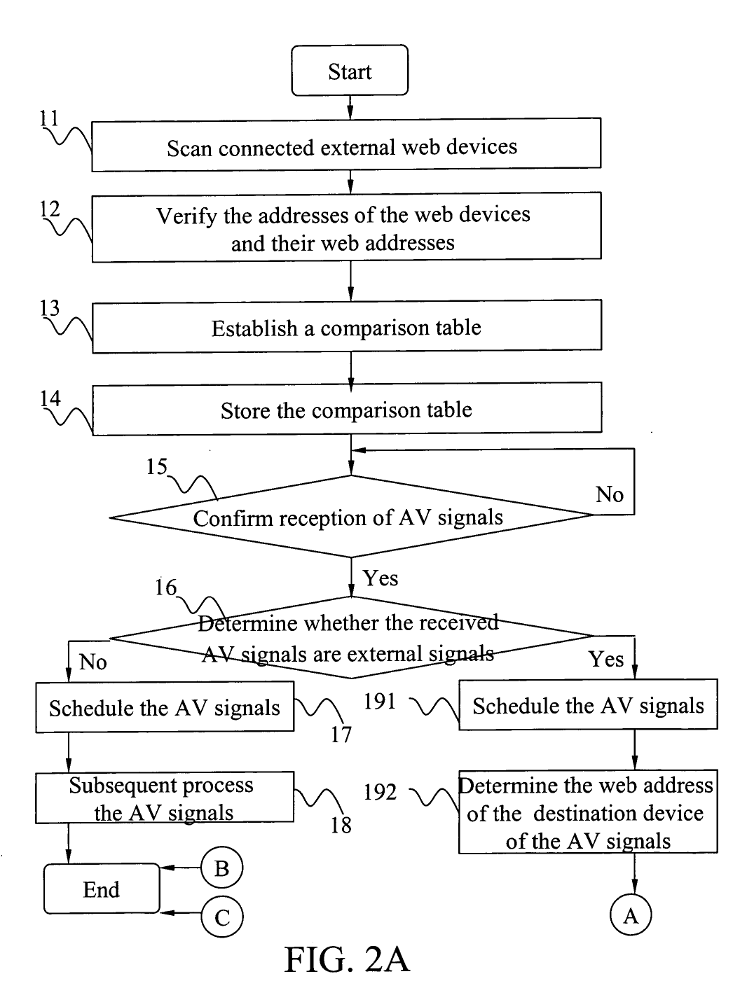

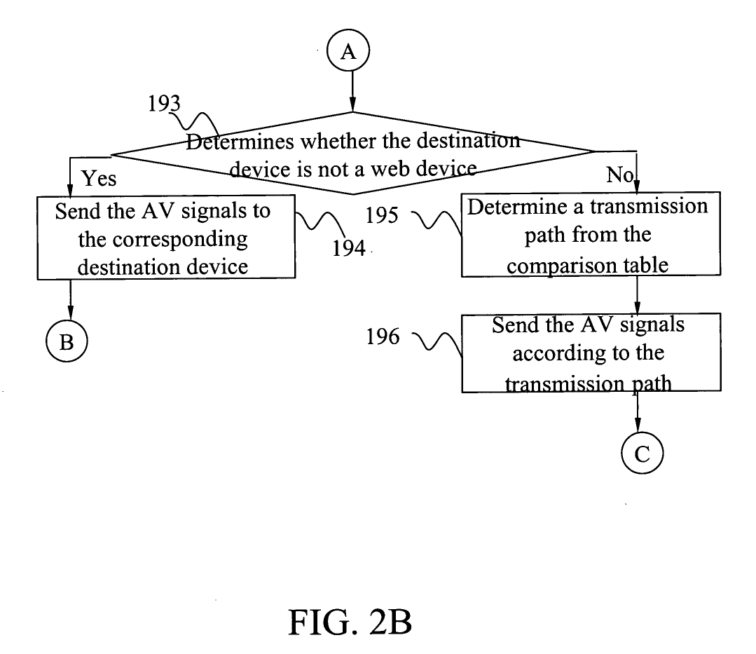

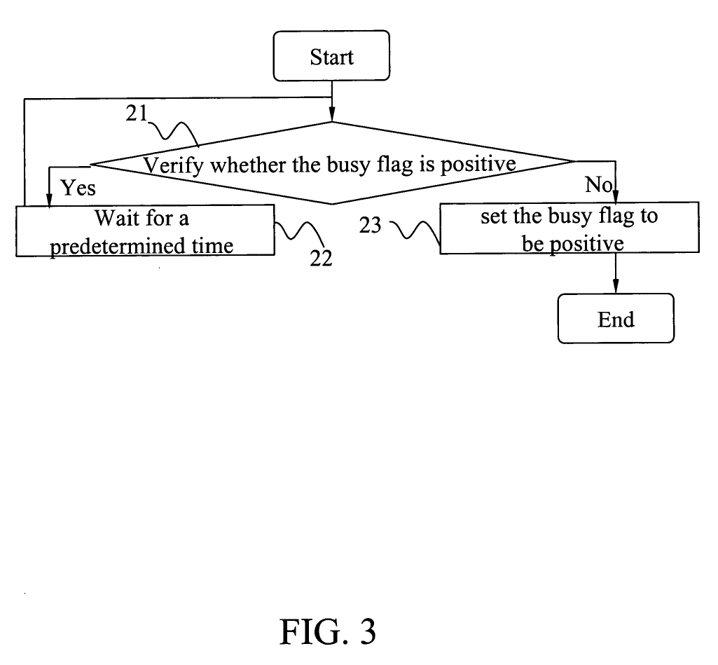

As shown in FIG. 2, the disclosed web AV recording method includes the following steps. First, the system scans connected external web devices (step 11) in order to know the number of web devices that are externally connected to the AV recording device. It then verifies the addresses of the web devices and their web addresses (step 12) in order to get the addresses of the web devices and their web addresses. A comparison table is established using the web device addresses and their web addresses (step 13). The comparison table is stored (step 14). From steps 11 to 14, the address and web address of each web device connected to the web AV recording device are obtained. Step 15 confirms reception of AV signals. The system determines whether the received AV signals are external signals (step 16). If they are not, the AV signals are scheduled (step 17) for subsequent processing (step 18). If they are external signals, the AV signals are scheduled (step 191) and their destination device along with the web address are determined (step 192). The system then determines whether the destination device is not a web device (step 193). If it is not a web device, the AV signals are sent to the corresponding destination device (step 194). If it is a web device, determine a transmission path from the comparison table (step 195), and send the AV signals according to the transmission path (step 196). Of course, steps 17 and 191 can further include the step of verifying whether the busy flag is positive (step 21). If the busy flag is positive, the system waits for a predetermined time (step 22). If the busy flag is negative, then the system sets it to be positive (step 23) in order to determine the time for processing the AV signals.

In addition to processing its own AV signals, the invention can further process external AV signals or transmit AV signals from one web device to another for further processing. Therefore, the web transmission function provided by the invention makes signal transmissions more convenient.

Certain variations would be apparent to those skilled in the art, which variations are considered within the spirit and scope of the claimed invention.

1. A web audio/video (AV) recording device comprising:
a connector, which connects to an external web device;
a transceiver, which connects to the connector for transceiving an AV signal;
a storage device, which stores a comparison table consisting of correspondence relations between web device addresses and their corresponding web addresses; and
a processor, which connects to the transceiver and the storage device;
wherein after receiving the AV signal transmitted by the transceiver, the processor schedules the AV signal for processing when the AV signal is determined to be an internal signal, and schedules the AV signal for transmission when the AV signal is determined to be an external signal and the destination web address is found to be a web device from the comparison table.

2. The web AV recording device of claim 1, wherein the transceiver receives and sends the web device addresses and their web corresponding addresses and the processor has an address comparison module so as to establish the comparison table when receiving the web device addresses and the corresponding web addresses from the transceiver.

3. The web AV recording device of claim 1, wherein the processor has a signal determination module to determine whether the AV signal is an internal signal or an external signal.

4. The web AV recording device of claim 1, wherein the processor has a signal processing module to process the signal once the AV signal is determined to be an internal signal or an external signal.

5. A web AV recording method comprising the steps of:
verifying that an AV signal is received;
determining that the AV signal is an external signal;
scheduling the AV signal;
determining a destination web address of a destination device for the AV signal;
verifying that the destination device is a web device;
determining a transmission path using a comparison table, which comprises the correspondence relations between web device addresses and their web addresses; and
transmitting the AV signal to the destination device.

6. The method of claim 5, wherein the step of verifying that an AV signal is received is proceeded by the steps of:
scanning the externally connected web device;
identifying the addresses and the web addresses of the web devices;
establishing the comparison table according to the addresses and the web addresses of the web devices; and
storing the comparison table.

7. The method of claim 5, wherein the step of scheduling the AV signal further includes the steps of:
determining a busy flag positive; and
waiting a predetermined time.

8. The method of claim 7, wherein as the result of the step of determining a busy flag positive is non-positive, the busy flag is set to be positive.
